(19) United States
(12) Patent Application Publication
(10) Pub. No.: US 2024/0340396 A1
(43) Pub. Date: Oct. 10, 2024

(54) DERIVATION DEVICE, DERIVATION METHOD, AND PROGRAM

(71) Applicant: FUJIFILM Corporation, Tokyo (JP)

(72) Inventor: Yuya NISHIO, Saitama-shi (JP)

(73) Assignee: FUJIFILM Corporation, Tokyo (JP)

(21) Appl. No.: 18/748,035

(22) Filed: Jun. 19, 2024

Related U.S. Application Data
(63) Continuation of application No. PCT/JP2022/043824, filed on Nov. 28, 2022.

(30) Foreign Application Priority Data
Dec. 24, 2021 (JP) 2021-211557

(51) Int. Cl. H04N 9/73; G06T 5/00

(52) U.S. Cl. CPC H04N 9/73; G06T 5/00; G06T 2207/10024

(57) ABSTRACT

There is provided a derivation device that derives a correction amount for correcting a color of image data obtained by imaging a subject, the derivation device including a processor, in which the processor is configured to: in a case where two or more pieces of processing are executable among first derivation processing of deriving first correction information without using a machine-learned model, second derivation processing of deriving second correction information using the image data and the machine-learned model, and third derivation processing of executing the first derivation processing and the second derivation processing, execute selection processing of selecting any one piece of processing of the first derivation processing, the second derivation processing, or the third derivation processing based on subject information of the subject; and execute correction amount derivation processing of deriving the correction amount based on information obtained by the processing selected by the selection processing.

### CROSS-REFERENCE TO RELATED APPLICATION

This application is a continuation application of International Application No. PCT/JP2022/043824, filed Nov. 28, 2022, the disclosure of which is incorporated herein by reference in its entirety. Further, this application claims priority from Japanese Patent Application No. 2021-211557 filed on Dec. 24, 2021, the disclosure of which is incorporated herein by reference in its entirety.

### BACKGROUND

### 1. Technical Field

The technology of the present disclosure relates to a derivation device, a derivation method, and a program.

### 2. Description of the Related Art

JP2013-168723A discloses an image processing apparatus including a plurality of determination units each of which obtains a similarity between a color gamut of each of preset reference scenes and an imaging scene of a target image by using a feature amount of the target image, and a specifying unit that specifies coordinate points in a color space corresponding to the imaging scene according to a correlation between a plurality of similarities acquired from the plurality of determination units.

A training data storage unit disclosed in JP2018-148281A stores training data including a plurality of pieces of image data and a category number of a light source. A machine learning unit performs machine learning of a criterion for determining a category of a light source, and stores a learned determination criterion (classifier) in a relevant parameter storage unit. A light source identification unit classifies categories of initial estimated vectors using a classifier stored in the relevant parameter storage unit, and outputs data such as the categories of one or more light sources of a scene obtained by imaging a frame and a distance between the category of the light source and the initial estimated vector in the feature space to a white balance correction unit.

### SUMMARY

An object of one embodiment according to the technology of the present disclosure is to provide a derivation device, a derivation method, and a program capable of deriving a correction amount with high accuracy.

In order to achieve the above object, according to the present disclosure, there is provided a derivation device that derives a correction amount for correcting a color of image data obtained by imaging a subject, the derivation device including a processor, in which the processor is configured to: in a case where two or more pieces of processing are executable among first derivation processing of deriving first correction information without using a machine-learned model, second derivation processing of deriving second correction information using the image data and the machine-learned model, and third derivation processing of executing the first derivation processing and the second derivation processing, execute selection processing of selecting any one piece of processing of the first derivation processing, the second derivation processing, or the third derivation processing based on subject information of the subject; and execute correction amount derivation processing of deriving the correction amount based on information obtained by the processing selected by the selection processing.

Preferably, the subject information is one or more pieces of information selected from color information of the subject, brightness information of the subject, and subject recognition information.

Preferably, the correction amount is a correction amount related to white balance correction.

Preferably, the processor is configured to execute the first derivation processing and the third derivation processing, and in the selection processing, select any one piece of processing from the first derivation processing or the third derivation processing.

Preferably, the processor is configured to, in a case where the third derivation processing is selected in the selection processing, calculate light source determination information related to a type of a light source as the second correction information in the second derivation processing, and calculate the correction amount based on information obtained by correcting the first correction information based on the light source determination information.

Preferably, the subject information is brightness information or color information of the subject.

Preferably, the processor is configured to calculate the brightness information or the color information based on the image data.

Preferably, the color information is integration information obtained by integrating pixel signals for each color with respect to a plurality of areas of the image data.

Preferably, in the first derivation processing, reference information including an evaluation value corresponding to the brightness information and the color information is used, and the processor is configured to acquire, as the first correction information, the evaluation value corresponding to the subject information based on the reference information in the first derivation processing.

Preferably, the processor is configured to, in the selection processing, select one piece of processing based on subject recognition information as the subject information.

Preferably, the processor is configured to repeatedly execute the first derivation processing and the second derivation processing in the third derivation processing, and a frequency at which the second derivation processing is executed is lower than a frequency at which the first derivation processing is executed.

Preferably, in the selection processing, any one piece of processing of the first derivation processing in which the second correction information is not combined, the second derivation processing in which the first correction information is not combined, or the third derivation processing is selected based on the subject information.

According to the present disclosure, there is provided a derivation method of deriving a correction amount for correcting a color of image data obtained by imaging a subject, the derivation method including: in a case where two or more processes are executable among a first derivation process of deriving first correction information without using a machine-learned model, a second derivation process of deriving second correction information using the image data and the machine-learned model, and a third derivation process of executing the first derivation process and the second derivation process, executing a selection process of selecting any one process of the first derivation process, the second derivation process, or the third derivation process based on subject information of the subject; and executing a correction amount derivation process of deriving the correction amount based on information obtained by the process selected by the selection process.

According to the present disclosure, there is provided a program causing a computer to execute derivation processing of deriving a correction amount for correcting a color of image data obtained by imaging a subject, the program causing the computer to execute a process including: in a case where two or more pieces of processing are executable among first derivation processing of deriving first correction information without using a machine-learned model, second derivation processing of deriving second correction information using the image data and the machine-learned model, and third derivation processing of executing the first derivation processing and the second derivation processing, selection processing of selecting any one piece of processing of the first derivation processing, the second derivation processing, or the third derivation processing based on subject information of the subject; and correction amount derivation processing of deriving the correction amount based on information obtained by the processing selected by the selection processing.

### BRIEF DESCRIPTION OF THE DRAWINGS

Exemplary embodiments according to the technique of the present disclosure will be described in detail based on the following figures, wherein:

FIG. 1 is a diagram illustrating an example of a configuration of an imaging apparatus,

FIG. 2 is a diagram illustrating an example of a configuration of a processor,

FIG. 3 is a diagram illustrating an example of integration processing,

FIG. 4 is a diagram illustrating an example of a distribution of points in a color space that are plotted based on integration information,

FIG. 5 is a diagram illustrating an example of a target coordinate determined by a target coordinate determination unit,

FIG. 6 is a diagram illustrating an example of processing of estimating a color temperature of a light source by an evaluation value acquisition unit,

FIG. 7 is a diagram illustrating an example of a reference table,

FIG. 8 is a diagram schematically illustrating white balance correction in a case where LW=50,

FIG. 9 is a diagram illustrating an example of a configuration of a light source determination unit,

FIG. 10 is a flowchart illustrating an example of a flow of evaluation value correction processing,

FIG. 11 is a diagram illustrating an example of defining a selection coefficient,

FIG. 12 is a sequence diagram illustrating an example of a flow of processing of an imaging sensor, a main processor, an AI processor, and an image processing processor, and

FIG. 13 is a diagram illustrating an example in which, in third derivation processing, a frequency at which second derivation processing is executed is set to be lower than a frequency at which first derivation processing is executed.

### DETAILED DESCRIPTION

An example of an embodiment according to the technology of the present disclosure will be described with reference to the accompanying drawings.

First, the terms used in the following description will be described.

In the following description, “IC” is an abbreviation for “integrated circuit”. “CPU” is an abbreviation for “central processing unit”. “ROM” is an abbreviation for “read only memory”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”. “AI” is an abbreviation for “artificial intelligence”. “CNN” is an abbreviation for “convolutional neural network”. “LED” is an abbreviation for “light emitting diode”.

As an embodiment of an imaging apparatus, the technology of the present disclosure will be described using a lens-interchangeable digital camera as an example. Note that the technology of the present disclosure is not limited to the lens-interchangeable type and can also be applied to a lens-integrated digital camera.

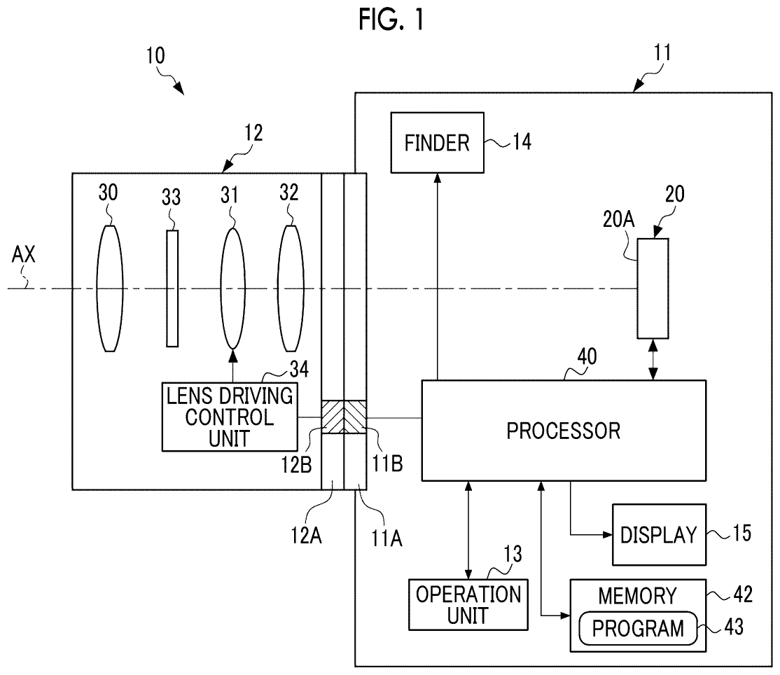

FIG. 1 illustrates an example of a configuration of an imaging apparatus 10. The imaging apparatus 10 is a lens-interchangeable digital camera. The imaging apparatus 10 includes a body 11 and an imaging lens 12 interchangeably mounted on the body 11. The imaging lens 12 is attached to a front surface side of the body 11 via a camera-side mount 11A and a lens-side mount 12A.

The body 11 is provided with an operation unit 13 including a dial, a release button, and the like. Examples of an operation mode of the imaging apparatus 10 include a still image capturing mode, a video capturing mode, and an image display mode. The operation unit 13 is operated by a user upon setting the operation mode. In addition, the operation unit 13 is operated by the user in a case of starting the execution of still image capturing or video capturing.

Further, the body 11 is provided with a finder 14. Here, the finder 14 is a hybrid finder (registered trademark). The hybrid finder refers to, for example, a finder in which an optical view finder (hereinafter, referred to as “OVF”) and an electronic view finder (hereinafter, referred to as “EVF”) are selectively used. The user can observe an optical image or a live view image of a subject projected onto the finder 14 via a finder eyepiece portion (not illustrated).

In addition, a display 15 is provided on a rear surface side of the body 11. The display 15 displays an image based on an image signal obtained through imaging, various menu screens, and the like.

The body 11 and the imaging lens 12 are electrically connected to each other through contact between an electrical contact 11B provided on the camera-side mount 11A and an electrical contact 12B provided on the lens-side mount 12A.

The imaging lens 12 includes an objective lens 30, a focus lens 31, a rear end lens 32, and a stop 33. Each member is disposed in the order of the objective lens 30, the stop 33, the focus lens 31, and the rear end lens 32 from the objective side along an optical axis AX of the imaging lens 12. The objective lens 30, the focus lens 31, and the rear end lens 32 constitute an imaging optical system. The type, the number, and the arrangement order of the lenses constituting the imaging optical system are not limited to the example illustrated in FIG. 1.

In addition, the imaging lens 12 includes a lens driving control unit 34. The lens driving control unit 34 includes, for example, a CPU, a RAM, a ROM, and the like. The lens driving control unit 34 is electrically connected to a processor 40 inside the body 11 via the electrical contact 12B and the electrical contact 11B.

The lens driving control unit 34 drives the focus lens 31 and the stop 33 based on a control signal transmitted from the processor 40. The lens driving control unit 34 performs drive control of the focus lens 31 based on a control signal for focusing control transmitted from the processor 40 in order to adjust a focusing position of the imaging lens 12. The processor 40 performs focus adjustment of a phase difference method.

The stop 33 has an opening in which an opening diameter is variable with the optical axis AX as a center. The lens driving control unit 34 performs drive control of the stop 33 based on a control signal for stop adjustment that is transmitted from the processor 40, in order to adjust an amount of light incident on a light-receiving surface 20A of an imaging sensor 20.

Further, the imaging sensor 20, the processor 40, and a memory 42 are provided inside the body 11. The operations of the imaging sensor 20, the memory 42, the operation unit 13, the finder 14, and the display 15 are controlled by the processor 40.

The processor 40 includes, for example, a CPU, a RAM, a ROM, and the like. In such a case, the processor 40 executes various types of processing based on a program 43 stored in the memory 42. Note that the processor 40 may be configured by an assembly of a plurality of IC chips.

The imaging sensor 20 is, for example, a CMOS-type image sensor. The imaging sensor 20 is disposed such that the optical axis AX is orthogonal to the light-receiving surface 20A and the optical axis AX is located at the center of the light-receiving surface 20A. Light (subject image) that has passed through the imaging lens 12 is incident on the light-receiving surface 20A. A plurality of pixels for generating image signals through photoelectric conversion are formed on the light-receiving surface 20A. The imaging sensor 20 generates and outputs an image signal by photoelectrically converting the light incident on each pixel.

In addition, a color filter array of a Bayer array is disposed on the light-receiving surface of the imaging sensor 20, and a color filter of any of red (R), green (G), or blue (B) is disposed to face each pixel. In the present embodiment, the imaging sensor 20 outputs color image data DT including an R pixel signal, a G pixel signal, and a B pixel signal for each pixel.

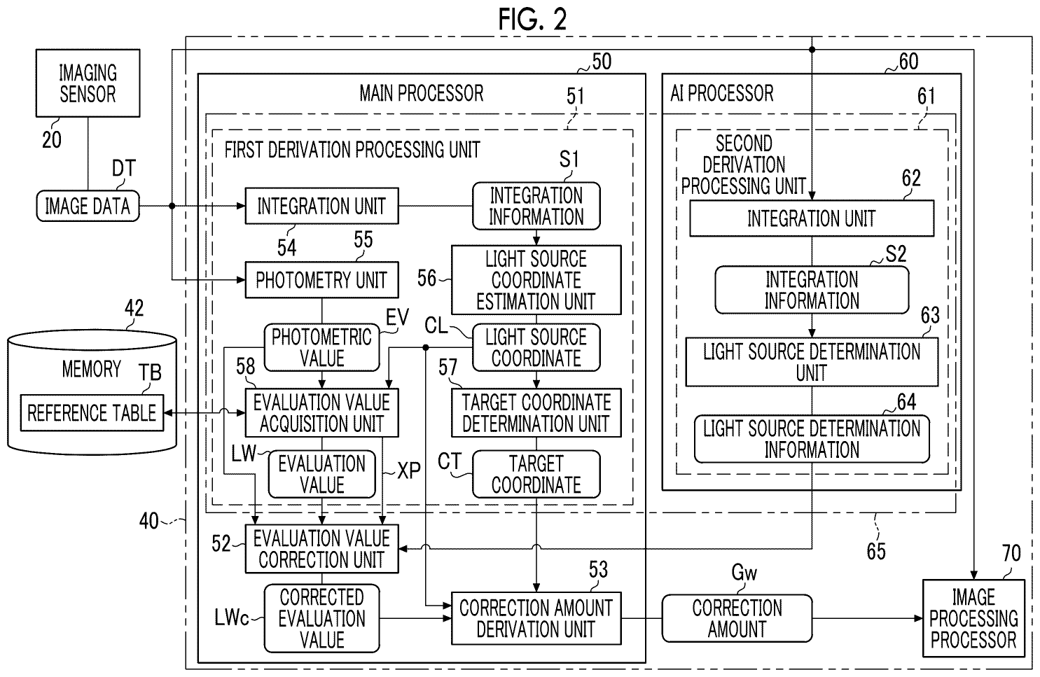

FIG. 2 illustrates an example of a configuration of the processor 40. The processor 40 includes a main processor 50, an AI processor 60, and an image processing processor 70. The main processor 50 overall controls the entire imaging apparatus 10, and performs calculation for deriving a correction amount or the like to be used by the image processing processor 70. The AI processor 60 performs calculation using the image data DT and a machine-learned model. The processor 40 is an example of a “derivation device” according to the technology of the present disclosure.

The image processing processor 70 performs image processing on the image data DT output from the imaging sensor 20. For example, the image processing processor 70 performs demosaicing, white balance correction, y correction, contour correction, and the like on the image data DT. The white balance correction is a function of correcting an influence of a color of light in the imaging environment such that a white object appears in white. The white balance correction can remove a so-called “color cast” in which the overall tone of the image data DT is biased to a specific color due to an influence of a color of a light source.

FIG. 2 illustrates a configuration related to a function of deriving a correction amount Gw among various functions executed by the main processor 50 and the AI processor 60. The correction amount Gw is a correction amount related to white balance correction. The main processor 50 is configured with a first derivation processing unit 51, an evaluation value correction unit 52, and a correction amount derivation unit 53. The AI processor 60 is configured with a second derivation processing unit 61. Further, a third derivation processing unit 65 is configured with the first derivation processing unit 51 and the second derivation processing unit 61.

The processor 40 including the main processor 50 and the AI processor 60 is configured to execute two or more pieces of processing among first derivation processing, second derivation processing, and third derivation processing of executing the first derivation processing and the second derivation processing, which will be described later. Preferably, the processor 40 is configured to execute two or more pieces of processing among the first derivation processing in which second correction information is not combined, the second derivation processing in which first correction information is not combined, and the third derivation processing.

The image data DT output from the imaging sensor 20 is supplied to the first derivation processing unit 51, the second derivation processing unit 61, and the image processing processor 70, for example, via the memory 42.

The first derivation processing unit 51 includes an integration unit 54, a photometry unit 55, a light source coordinate estimation unit 56, a target coordinate determination unit 57, and an evaluation value acquisition unit 58. The first derivation processing executed by the first derivation processing unit 51 is processing of deriving the first correction information without using a machine-learned model. The integration unit 54 calculates color information of a subject based on the image data DT. The photometry unit 55 calculates brightness information of the subject based on the image data DT.

The integration unit 54 generates integration information S1 by dividing the image data DT into a plurality of areas and integrating, for each of the plurality of divided areas, the pixel signals for each color. The integration information S1 generated by the integration unit 54 is supplied to the light source coordinate estimation unit 56.

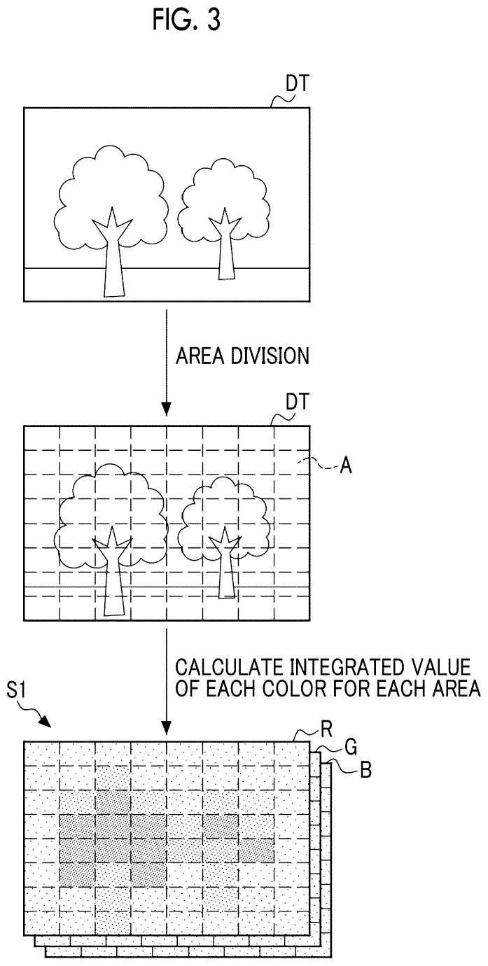

FIG. 3 illustrates an example of integration processing performed by the integration unit 54. For example, the integration unit 54 sets 64 areas A by dividing the image data DT into eight parts in each of a vertical direction and a horizontal direction. In addition, the integration unit 54 calculates an integrated value for each color by integrating each of the R pixel signal, the G pixel signal, and the B pixel signal for each area A. The integration information S1 includes an integrated value for each color in each area A. The integration information S1 is an example of “color information of the subject” that is included in the image data DT.

The photometry unit 55 divides the image data DT into a plurality of areas, and integrates the pixel signals for each of the plurality of divided areas. The integration processing by the photometry unit 55 differs from the integration processing by the integration unit 54 in that integration processing for each color is not performed. The photometry unit 55 calculates a photometric value EV based on the integrated value that is obtained. The photometric value EV generated by the photometry unit 55 is supplied to the evaluation value acquisition unit 58 and the evaluation value correction unit 52. The photometric value EV is an example of “brightness information of the subject” that is included in the image data DT. Further, the integration information S1 and the photometric value EV are an example of “subject information of the subject” according to the technology of the present disclosure. In the present disclosure, the subject does not mean a specific subject, and refers to all objects appearing in the image data DT.

Note that the photometric value EV calculated by the photometry unit 55 is not limited to the white balance correction and is also used for exposure control that determines an F number of the stop 33 and a shutter speed of the imaging sensor 20.

The light source coordinate estimation unit 56 acquires the integrated values of R, G, and B for each area A from the integration information S1, and obtains a ratio (R/G and B/G) of the integrated values of R, G, and B for each area A. The light source coordinate estimation unit 56 plots points corresponding to the obtained R/G value and the obtained B/G value in the color space for each area A. In addition, the light source coordinate estimation unit 56 estimates a light source coordinate CL based on a distribution of the plotted points in the color space. The light source coordinate CL estimated by the light source coordinate estimation unit 56 is supplied to the target coordinate determination unit 57, the evaluation value acquisition unit 58, and the correction amount derivation unit 53. The light source coordinate mean an estimated position of illumination light of the light source (an electric bulb, a fluorescent lamp, an LED, or the like) in the color space.

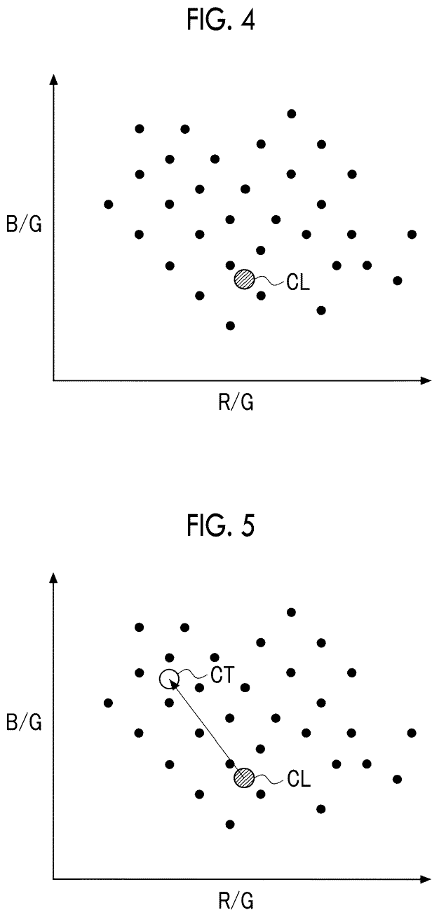

FIG. 4 is an example of the distribution of the points in the color space that are plotted by the light source coordinate estimation unit 56 based on the integration information S1. For example, the light source coordinate estimation unit 56 estimates the light source coordinate CL by weight-averaging the distribution of the points in the color space.

The target coordinate determination unit 57 determines a target coordinate CT to which the light source coordinate CL is moved by white balance correction, based on the light source coordinate CL. The target coordinate determination unit 57 supplies the determined target coordinate CT to the correction amount derivation unit 53.

FIG. 5 illustrates an example of the target coordinate CT determined by the target coordinate determination unit 57. In a case where the estimation of the light source coordinate CL by the light source coordinate estimation unit 56 is correct, that is, in a case where the light source coordinate CL accurately represents the color of the light source under the environment in which the image data DT is captured, color cast is removed with high accuracy by performing white balance correction such that the light source coordinate CL is moved to the target coordinate CT.

The evaluation value acquisition unit 58 acquires an evaluation value LW corresponding to the subject information from a reference table TB stored in the memory 42. The evaluation value LW is a value corresponding to accuracy of the estimation of the light source coordinate CL by the light source coordinate estimation unit 56. Further, the evaluation value LW represents a ratio at which the light source coordinate CL is moved to the target coordinate CT by the white balance correction. As the accuracy of the estimation of the light source coordinate CL is higher, that is, as the evaluation value LW is larger, a ratio at which the light source coordinate CL is moved to the target coordinate CT is higher.

Specifically, the evaluation value acquisition unit 58 calculates an index related to a color temperature of the light source based on the light source coordinate CL, and acquires the evaluation value LW corresponding to the calculated index and the photometric value EV from the reference table TB. Note that the reference table TB is an example of “reference information” according to the technique of the present disclosure. In addition, the evaluation value LW is an example of “first correction information” according to the technology of the present disclosure.

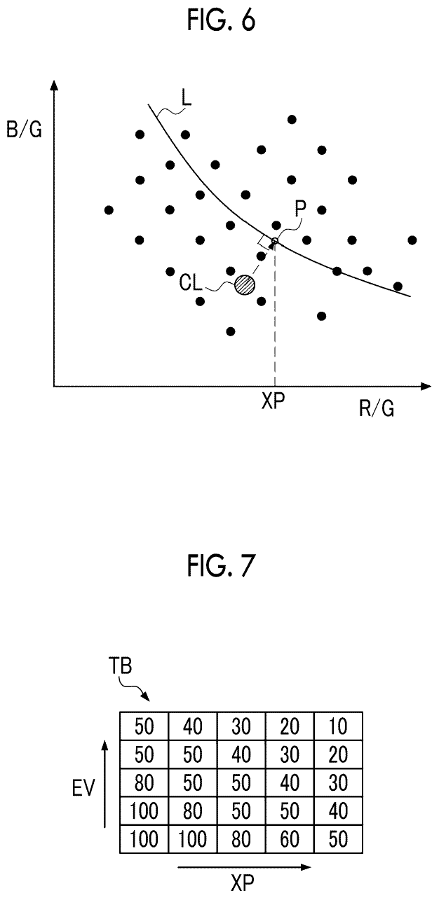

FIG. 6 illustrates an example of processing of estimating the color temperature of the light source by the evaluation value acquisition unit 58. As illustrated in FIG. 6, the evaluation value acquisition unit 58 obtains a closest point P having the shortest distance from the light source coordinate CL on a blackbody radiation trajectory L, and calculates an R/G value of the closest point P as an index XP. The blackbody radiation trajectory L is a trajectory obtained by representing a change due to a temperature of a color of light radiated by the blackbody in a color space.

FIG. 7 illustrates an example of the reference table TB. The evaluation value LW corresponding to the index XP and the photometric value EV is stored in the reference table TB. For example, the evaluation value LW has a value within a range equal to or larger than 0 and equal to or smaller than 100. The evaluation value LW differs depending on the index XP and the photometric value EV. This is because, in the processing of estimating the light source coordinate CL based on the color information, accuracy of the estimation varies depending on the brightness information. For example, in a case where the color indicated by the light source coordinate CL is a bright orange color, it is difficult to determine whether the color is caused by a color of the light source such as a bright light bulb (hereinafter, referred to as a light source color) or the color is caused by a color of an object such as autumn leaves or sunset (hereinafter, referred to as an object color). As described above, for example, in a case where the photometric value EV is large and the index XP related to the color temperature is large, accuracy of the estimation of the light source coordinate CL is lowered.

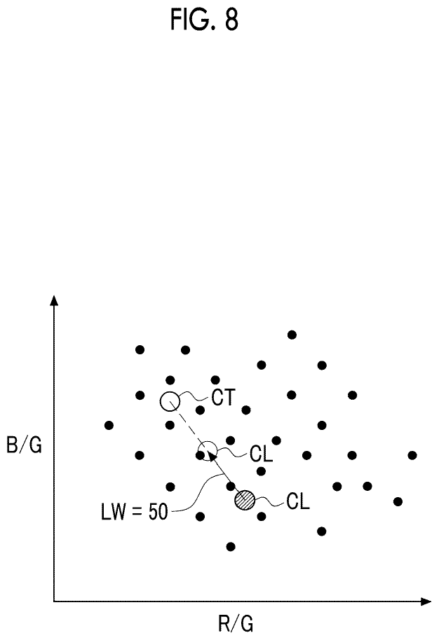

FIG. 8 schematically illustrates white balance correction in a case of LW=50. Further, FIG. 8 illustrates a position of the light source coordinate CL that is moved by white balance correction in a case where the evaluation value LW is not corrected by the evaluation value correction unit 52 to be described later. In a case of LW=50, the light source coordinate CL is moved to a position of 50% of the target coordinate CT.

Assuming that a correction amount for moving the light source coordinate CL to the target coordinate CT is “complete correction amount”, the correction amount in a case of LW=50 is 50% of the complete correction amount. In a case where LW =50 and the correct answer of the color indicated by the light source coordinate CL is “light source color”, color cast is removed by 50%. On the contrary, in a case where LW=50 and the correct answer of the color indicated by the light source coordinate CL is “object color”, color loss of the object color occurs. As described above, in a case of LW=50, regardless of whether the correct answer of the color indicated by the light source coordinate CL is “light source color” or “object color”, white balance correction cannot be performed with high accuracy.

Therefore, in the present embodiment, the evaluation value correction unit 52 selects whether to directly use the evaluation value LW derived by the first derivation processing unit 51 for calculation of the correction amount based on the subject information, or to correct the evaluation value LW based on the light source determination information 64 acquired by the second derivation processing unit 61. Specifically, the evaluation value correction unit 52 calculates a selection coefficient α based on the light source determination information 64 and the subject information, and in a case where a value of the selection coefficient α exceeds 0 (that is, α>0), sets the evaluation value LW to be close to 100 or 0. The light source determination information 64 is information related to a type of the light source. Specifically, the light source determination information 64 includes a determination result as to whether a color indicated by the light source coordinate CL is a “light source color” or an “object color”.

On the other hand, in a case where the value of the selection coefficient α is 0, the evaluation value LW does not need to be corrected, and thus the evaluation value LW can be directly used for calculation of the correction amount. In other words, the correction amount is calculated based on the evaluation value LW derived by the first derivation processing unit 51 without combination with the light source determination information acquired by the second derivation processing unit 61.

The second derivation processing unit 61 includes an integration unit 62 and a light source determination unit 63. The integration unit 62 has the same configuration as the integration unit 54 of the main processor 50, and generates integration information S2 based on the image data DT. Note that the number of area divisions of the image data DT by the integration unit 54 may be different from the number of area divisions of the image data DT by the integration unit 62. For example, the number of area divisions of the image data DT by the integration unit 62 may be larger than the number of area divisions of the image data DT by the integration unit 54.

The light source determination unit 63 is a machine-learned model, and derives the light source determination information 64 using the integration information S2 as input data. The second derivation processing executed by the second derivation processing unit 61 is processing of deriving second correction information using the image data DT and the machine-learned model. The light source determination information 64 is an example of “second correction information” according to the technology of the present disclosure. Note that, in a case where the correction amount is calculated only by the second derivation processing without combination with the first derivation processing to be described later, the correction amount Gw is an example of “second correction information”.

Note that the integration information SI generated by the integration unit 54 of the main processor 50 may be input to the light source determination unit 63 as the input data without providing the integration unit 62 in the second derivation processing unit 61. Further, in addition to the integration information S2 or the integration information S1, the photometric value EV may be input to the light source determination unit 63 as the input data. Furthermore, the image data DT may be input to the light source determination unit 63 as the input data.

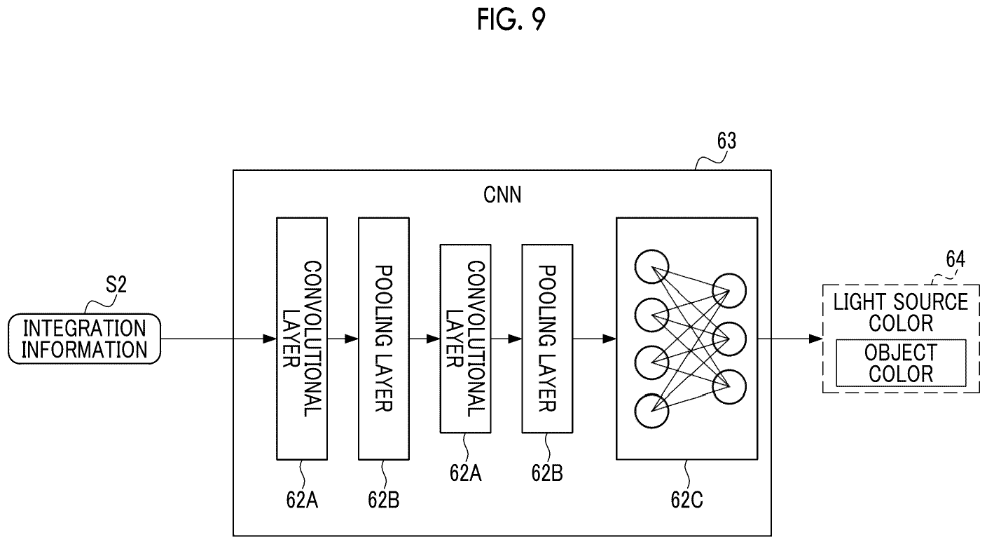

FIG. 9 illustrates an example of a configuration of the light source determination unit 63. For example, the light source determination unit 63 is a machine-learned model configured by a convolutional neural network (CNN). The light source determination unit 63 includes a plurality of convolutional layers 62A, a plurality of pooling layers 62B, and an output layer 62C. The convolutional layer 62A and the pooling layer 62B are alternately disposed, and a feature amount is extracted from the integration information S2 that is input to the light source determination unit 63.

The output layer 62C is configured with fully-connected layers. The output layer 62C determines whether the color indicated by the light source coordinate CL estimated based on the image data DT is a “light source color” or an “object color” based on the feature amounts extracted in the plurality of convolutional layers 62A and the plurality of pooling layers 62B, and outputs a determination result as the light source determination information 64.

The light source determination unit 63 is a machine-learned model obtained by performing machine learning using, as training data, the integration information S2 based on a large number of image data DT and correct answer data indicating whether the color indicated by the light source coordinate CL is a “light source color” or an “object color”. Note that the light source determination unit 63 may output whether the color is a “light source color” or an “object color” together with each score (a correct answer rate) as the light source determination information 64. For example, the light source determination unit 63 may output the light source determination information 64 in a format of a light source color (score: 80%), an object color (score: 20%), or the like.

The evaluation value correction unit 52 corrects the evaluation value LW based on the light source determination information 64, the photometric value EV, and the index XP. That is, the evaluation value correction unit 52 corrects the evaluation value LW to be close to 100 or 0 based on the determination result as to whether the color indicated by the light source coordinate CL is a “light source color” or an “object color” and the subject information (the brightness information and the color information).

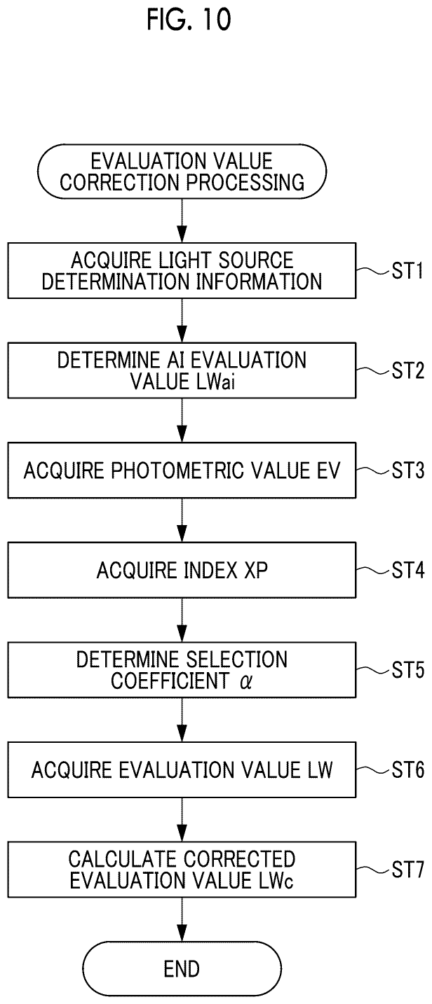

FIG. 10 illustrates an example of a flow of evaluation value correction processing by the evaluation value correction unit 52. First, the evaluation value correction unit 52 acquires the light source determination information 64 from the light source determination unit 63 (step ST1), and determines the AI evaluation value LWai based on the acquired light source determination information 64 (step ST2). For example, the evaluation value correction unit 52 sets LWai=100 in a case where the determination result included in the light source determination information 64 is “light source color”, and sets LWai=0 in a case where the determination result is “object color”. Note that the evaluation value correction unit 52 may set the AI evaluation value LWai to a value between 0 and 100 in consideration of the score.

Next, the evaluation value correction unit 52 acquires the photometric value EV from the photometry unit 55 (step ST3), and acquires the index XP related to the color temperature from the evaluation value acquisition unit 58 (step ST4). In addition, the evaluation value correction unit 52 determines the selection coefficient α based on the photometric value EV and the index XP (step ST5). The selection coefficient α is a coefficient representing a selection ratio of the evaluation value LW and the AI evaluation value LWai. The selection coefficient α has a value within a range equal to or larger than 0 and equal to or smaller than 1.

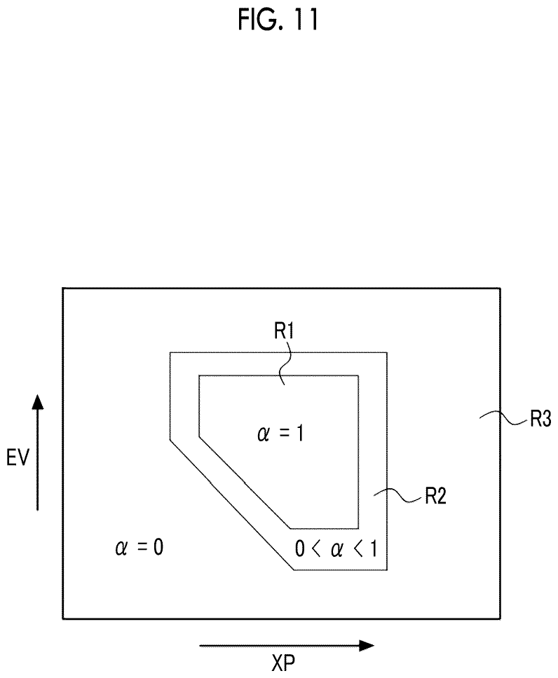

For example, the evaluation value correction unit 52 determines the selection coefficient α based on a relationship illustrated in FIG. 11. As illustrated in FIG. 11, the selection coefficient α is defined in a two-dimensional space in which the photometric value EV and the index XP are set as axes, and the two-dimensional space is divided into a first region R1, a second region R2, and a third region R3. In the first region R1, α=1. In the second region R2, 0 <α<1. In the third region R3, α=0. The first region R1 is a region in which the reliability of the evaluation value LW is low and the reliability of the AI evaluation value LWai is high. On the other hand, the third region R3 is a region in which the reliability of the evaluation value LW is high and the reliability of the AI evaluation value LWai is low. Note that the relationship illustrated in FIG. 11 may be stored in the memory 42 in a table format similarly to the reference table TB.

Next, the evaluation value correction unit 52 acquires the evaluation value LW from the evaluation value acquisition unit 58 (step ST6). In addition, the evaluation value correction unit 52 calculates a corrected evaluation value LWc based on the following Equation (1) using the AI evaluation value LWai determined in step ST2 and the selection coefficient α determined in step ST5 (step ST7).

$$LWc = LW \times ( 1 - α ) + LWai \times α \qquad ( 1 )$$

According to Equation (1), LWc=LWai in a case where α=1, and LWc=LW in a case where α=0.

The correction amount derivation unit 53 derives a correction amount Gw based on the following Equations (2) to (4) using the light source coordinate CL, the target coordinate CT, and the corrected evaluation value LWc. Gwr represents a correction gain for the R pixel signal. Gwg represents a correction gain for the G pixel signal. Gwb represents a correction gain for the B pixel signal.

$$Gwr = ( Gr - Rd ) \times \frac{LWc}{100} + Rd \qquad ( 2 )$$

$$Gwg = ( Gg - Gd ) \times \frac{LWc}{100} + Gd \qquad ( 3 )$$

$$Gwb = ( Gb - Bd ) \times \frac{LWc}{100} + Bd \qquad ( 4 )$$

Here, Gr, Gg, and Gb are complete correction amounts for the R pixel signal, the G pixel signal, and the B pixel signal, respectively. Rd, Gd, and Bd are equal-magnification correction amounts (also referred to as reference correction amounts). The complete correction amounts Gr, Gg, and Gb are represented by the following Equations (5) to (7).

$$Gr = Gd \times \frac{RGct}{RGcl} \qquad ( 5 )$$

$$Gg = Gd \qquad ( 6 )$$

$$Gb = Gb \times \frac{RGct}{RGcl} \qquad ( 7 )$$

Here, RGcl is an R/G value of the light source coordinate CL. BGcl is a B/G value of the light source coordinate CL. RGct is an R/G value of the target coordinate CT. BGct is a B/G value of the target coordinate CT.

The correction amount Gw derived by the correction amount derivation unit 53 is supplied to the image processing processor 70. The image processing processor 70 performs white balance correction of the image data DT based on the correction amount Gw. Specifically, the image processing processor 70 corrects the R pixel signal, the G pixel signal, and the B pixel signal included in the image data DT based on correction gains Gwr, Gwg, and Gwb, respectively.

As described above, in the present embodiment, the evaluation value correction unit 52 determines whether or not to correct the evaluation value LW using the selection coefficient α based on the index XP obtained from the image data DT and the photometric value EV. In an example in which the evaluation value LW is corrected by the main processor 50, as shown in Equation (1), this is a case where the corrected evaluation value LWc is derived by weighted addition of the evaluation value LW and the AI evaluation value LWai using the selection coefficient α. For example, even in a case where LW=50, the AI evaluation value LWai becomes 100 or 0 depending on the determination result of the light source determination unit 63, and thus the corrected evaluation value LWc approaches 100 or 0. Further, the weighted addition is performed based on the selection coefficient α representing the reliability of the AI evaluation value LWai, and thus a corrected evaluation value LWc with high accuracy is obtained. As described above, in the present embodiment, the correction amount Gw is calculated based on the corrected evaluation value LWc with high accuracy, and thus the correction amount Gw with high accuracy can be derived.

Thereby, incomplete removal of color cast, occurrence of color loss of the object color, and the like are prevented.

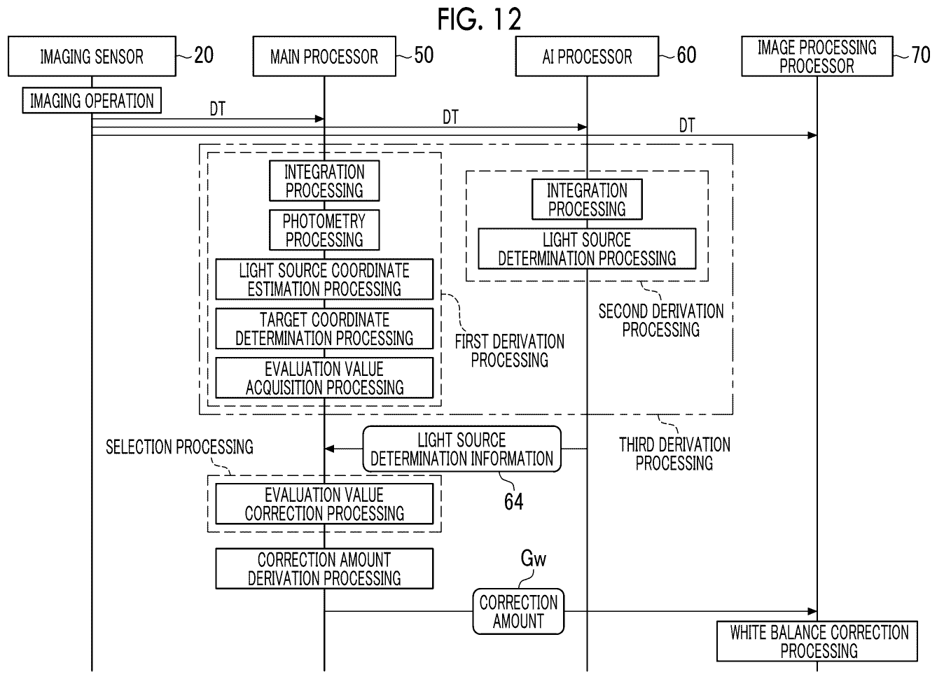

FIG. 12 is a sequence diagram illustrating an example of a flow of processing of the imaging sensor 20, the main processor 50, the AI processor 60, and the image processing processor 70. As illustrated in FIG. 12, in a case where the imaging sensor 20 generates the image data DT by performing an imaging operation, the image data DT is supplied to each of the main processor 50, the AI processor 60, and the image processing processor 70 via the memory 42.

The main processor 50 executes first derivation processing including integration processing, photometry processing, light source coordinate estimation processing, and evaluation value acquisition processing, based on the image data DT. The AI processor 60 executes second derivation processing including the integration processing and the light source determination processing in parallel to the first derivation processing.

In a case where the first derivation processing is ended, the main processor 50 executes the evaluation value correction processing of correcting the evaluation value LW as the first correction information derived by the first derivation processing based on the light source determination information 64 as the second correction information derived by the second derivation processing. In addition, the main processor 50 executes correction amount derivation processing of calculating the correction amount Gw based on the corrected evaluation value LWc as the information obtained by correcting the first correction information.

The image processing processor 70 executes white balance correction processing of correcting the color of the image data DT based on the correction amount Gw derived by the correction amount derivation processing.

The processing illustrated in FIG. 12 is repeatedly executed for each frame, which is an imaging cycle.

Note that the evaluation value correction processing is an example of “selection processing” according to the technology of the present disclosure. In the evaluation value correction processing according to the present embodiment, the evaluation value LW and the AI evaluation value LWai are selected based on the selection coefficient α determined based on the subject information. A case where α=0 corresponds to selection of the first derivation processing in which the light source determination information, which is the second correction information, is not combined because the AI evaluation value LWai is not used. A case where 0 <α>1 corresponds to selection of the third derivation processing. That is, in the present embodiment, the main processor 50 selects any one piece of processing from the first derivation processing and the third derivation processing in which the second correction information is not combined, based on the subject information.

Further, in the present embodiment, after the AI processor 60 calculates the light source determination information 64, the evaluation value correction unit 52 executes the selection processing. The main processor 50 may execute the selection processing based on the subject information and determine a necessity of derivation of the light source determination information 64 before the AI processor 60 derives the light source determination information 64.

### Modification Example

Next, various modification examples of the above embodiment will be described.

In the above embodiment, the first derivation processing and the second derivation processing are repeatedly executed in parallel for each frame. That is, in the above embodiment, the first derivation processing and the second derivation processing are executed at the same frequency. Since the second derivation processing using the machine learning model has a larger operation load than the first derivation processing, a frequency at which the second derivation processing is executed may be lower than a frequency at which the first derivation processing is executed.

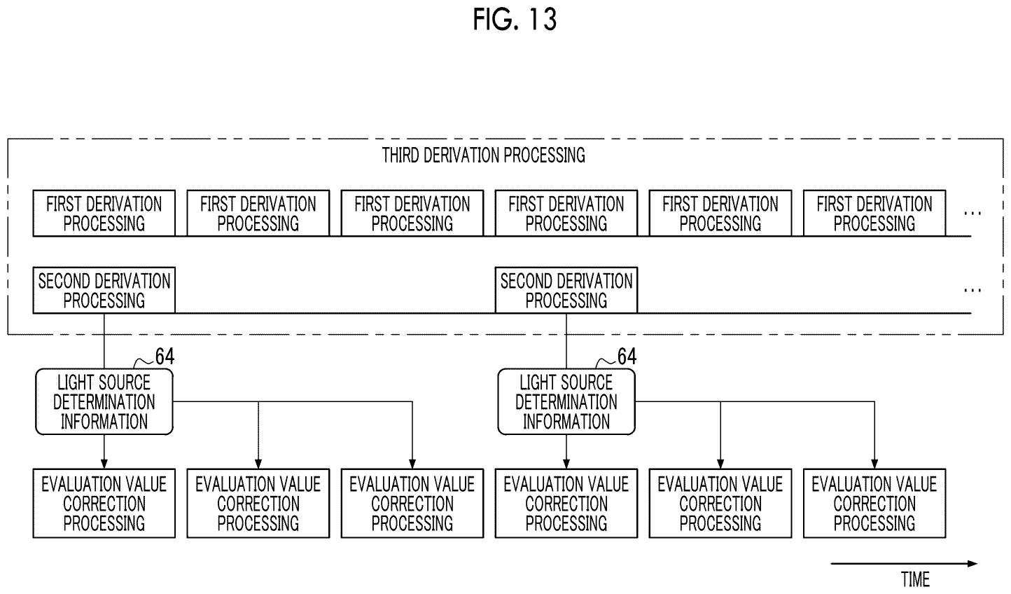

FIG. 13 illustrates an example in which, in the third derivation processing, a frequency at which the second derivation processing is executed is set to be lower than a frequency at which the first derivation processing is executed. In the example illustrated in FIG. 13, the first derivation processing is executed every frame, whereas the second derivation processing is executed every three frames. In this case, the light source determination information 64 is obtained only every three frames. Therefore, in a frame in which the second derivation processing is not executed, the evaluation value correction unit 52 performs evaluation value correction processing by using the light source determination information 64 generated in the most recent frame in which the second derivation processing is executed.

Further, in the above embodiment, the selection coefficient α is defined in the two-dimensional space in which the photometric value EV and the index XP are set as the axes. On the other hand, the selection coefficient α may be defined in a three-dimensional space in which the photometric value EV, the R/G value, and the B/G value are set as the axes. In this case, the evaluation value correction unit 52 may determine the selection coefficient α based on the photometric value EV and the R/G value and the B/G value of the closest point P.

Similarly, in the reference table TB, the evaluation value LW may be defined in a three-dimensional space in which the photometric value EV, the R/G value, and the B/G value are set as the axes. In this case, the evaluation value acquisition unit 58 may acquire the evaluation value LW based on the photometric value EV and the R/G value and the B/G value of the closest point P.

Further, in the above embodiment, the evaluation value correction unit 52 determines the selection coefficient α based on the brightness information and the color information as the subject information. On the other hand, the selection coefficient α may be determined based on subject recognition information as the subject information. That is, any one piece of processing of the first derivation processing or the third derivation processing may be selected based on the subject recognition information. The subject recognition information is a type of the subject appearing in the image data DT, and is, for example, an imaging scene. For example, the evaluation value correction unit 52 determines whether or not the imaging scene is a scene in which accuracy of the estimation of the light source coordinate CL by the light source coordinate estimation unit 56 is high based on the image data DT, and sets the selection coefficient α to a large value in a case where the imaging scene is a scene in which accuracy of the estimation is low. On the contrary, the evaluation value correction unit 52 sets the selection coefficient α to a small value in a case where the imaging scene is a scene in which accuracy of the estimation is high.

In addition, in the above embodiment, in the second derivation processing, which is a part of the third derivation processing and in which the evaluation value LW as the first correction information is combined, the light source determination information 64 is derived using the image data DT and the machine-learned model. Instead of the third derivation processing, the processor 40 may be configured to execute the second derivation processing in which the evaluation value LW as the first correction information is not combined. In this case, in the second derivation processing, the correction amount to be used in the white balance correction may be derived using the image data DT and the machine-learned model. In addition, in the selection processing, the first derivation processing that derives the correction amount without using the machine-learned model, and the second derivation processing that derives the correction amount using the machine-learned model are selected based on the subject information.

As another embodiment, in the selection processing, three pieces of processing of the first derivation processing, the second derivation processing, and the third derivation processing may be selected based on the subject information. In this case, any one piece of processing of the three pieces of processing may be selected based on the subject information of the image data DT. Note that the subject information may be one or more pieces of information selected from the brightness information of the subject, the color information of the subject, and the subject recognition information.

The technology of the present disclosure is not limited to the digital camera and can also be applied to electronic devices such as a smartphone and a tablet terminal having an imaging function.

In the above-described embodiment, various processors to be described below can be used as the hardware structure of the control unit using the processor 40 as an example. The above-described various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured by one of these various processors or a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured as one processor can be considered. As a first example, there is an aspect in which one or more CPUs and software are combined to configure one processor and the processor functions as a plurality of control units, as represented by a computer such as a client and a server. As a second example, there is an aspect in which a processor that implements the functions of the entire system, which includes a plurality of control units, with one IC chip is used, as represented by system on chip (SOC). In this way, the control unit can be configured by using one or more of the above-described various processors as the hardware structure.

Furthermore, more specifically, it is possible to use an electrical circuit in which circuit elements such as semiconductor elements are combined, as the hardware structure of these various processors.

The described contents and the illustrated contents are detailed explanations of a part according to the technique of the present disclosure, and are merely examples of the technique of the present disclosure. For example, the descriptions related to the configuration, the function, the operation, and the effect are descriptions related to examples of a configuration, a function, an operation, and an effect of a part according to the technique of the present disclosure. Therefore, it goes without saying that, in the described contents and illustrated contents, unnecessary parts may be deleted, new components may be added, or replacements may be made without departing from the spirit of the technique of the present disclosure. Further, in order to avoid complications and facilitate understanding of the part according to the technique of the present disclosure, in the described contents and illustrated contents, descriptions of technical knowledge and the like that do not require particular explanations to enable implementation of the technique of the present disclosure are omitted.

All documents, patent applications, and technical standards described in this specification are incorporated herein by reference to the same extent as in a case where each document, each patent application, and each technical standard are specifically and individually described by being incorporated by reference.

What is claimed is:

1. A derivation device that derives a correction amount for correcting a color of image data obtained by imaging a subject, the derivation device comprising:
a processor,
wherein the processor is configured to:
in a case where two or more pieces of processing are executable among first derivation processing of deriving first correction information without using a machine-learned model, second derivation processing of deriving second correction information using the image data and the machine-learned model, and third derivation processing of executing the first derivation processing and the second derivation processing,
execute selection processing of selecting any one piece of processing of the first derivation processing, the second derivation processing, or the third derivation processing based on subject information of the subject; and
execute correction amount derivation processing of deriving the correction amount based on information obtained by the processing selected by the selection processing.

2. The derivation device according to claim 1,
wherein the subject information is one or more pieces of information selected from color information of the subject, brightness information of the subject, and subject recognition information.

3. The derivation device according to claim 1,
wherein the correction amount is a correction amount related to white balance correction.

4. The derivation device according to claim 1,
wherein the processor is configured to execute the first derivation processing and the third derivation processing, and in the selection processing, select any one piece of processing from the first derivation processing or the third derivation processing.

5. The derivation device according to claim 1,
wherein the processor is configured to:
in a case where the third derivation processing is selected in the selection processing,
calculate light source determination information related to a type of a light source as the second correction information in the second derivation processing, and
calculate the correction amount based on information obtained by correcting the first correction information based on the light source determination information.

6. The derivation device according to claim 5,
wherein the subject information is brightness information or color information of the subject.

7. The derivation device according to claim 6,
wherein the processor is configured to calculate the brightness information or the color information based on the image data.

8. The derivation device according to claim 7,
wherein the color information is integration information obtained by integrating pixel signals for each color with respect to a plurality of areas of the image data.

9. The derivation device according to claim 6,
wherein, in the first derivation processing, reference information including an evaluation value corresponding to the brightness information and the color information is used, and
the processor is configured to acquire, as the first correction information, the evaluation value corresponding to the subject information based on the reference information in the first derivation processing.

10. The derivation device according to claim 1,
wherein the processor is configured to, in the selection processing, select one piece of processing based on subject recognition information as the subject information.

11. The derivation device according to claim 1,
wherein the processor is configured to repeatedly execute the first derivation processing and the second derivation processing in the third derivation processing, and
a frequency at which the second derivation processing is executed is lower than a frequency at which the first derivation processing is executed.

12. The derivation device according to claim 1,
wherein, in the selection processing, any one piece of processing of the first derivation processing in which the second correction information is not combined, the second derivation processing in which the first correction information is not combined, or the third derivation processing is selected based on the subject information.

13. A derivation method of deriving a correction amount for correcting a color of image data obtained by imaging a subject, the derivation method comprising:
in a case where two or more processes are executable among a first derivation process of deriving first correction information without using a machine-learned model, a second derivation process of deriving second correction information using the image data and the machine-learned model, and a third derivation process of executing the first derivation process and the second derivation process,
executing a selection process of selecting any one process of the first derivation process, the second derivation process, or the third derivation process based on subject information of the subject; and
executing a correction amount derivation process of deriving the correction amount based on information obtained by the process selected by the selection process.

14. A non-transitory computer-readable storage medium storing a program causing a computer to execute derivation processing of deriving a correction amount for correcting a color of image data obtained by imaging a subject, the program causing the computer to execute a process comprising:
in a case where two or more pieces of processing are executable among first derivation processing of deriving first correction information without using a machine-learned model, second derivation processing of deriving second correction information using the image data and the machine-learned model, and third derivation processing of executing the first derivation processing and the second derivation processing,
selection processing of selecting any one piece of processing of the first derivation processing, the second derivation processing, or the third derivation processing based on subject information of the subject; and
correction amount derivation processing of deriving the correction amount based on information obtained by the processing selected by the selection processing.
